(19) United States
(12) Patent Application Publication
(10) Pub. No.: US 2026/0233784 A1
(43) Pub. Date: Aug. 13, 2026

(54) VEHICLE STRUCTURE

(71) Applicant: Honda Motor Co., Ltd., Tokyo (JP)

(72) Inventor: Yuya KAWANO, Tokyo (JP)

(73) Assignee: Honda Motor Co., Ltd., Tokyo (JP)

(21) Appl. No.: 19/386,122

(22) Filed: Nov. 11, 2025

(30) Foreign Application Priority Data
Feb. 10, 2025 (CN) 202510146663.2

(51) Int. Cl. B62D 25/08; B62D 21/15

(52) U.S. Cl. CPC B62D 25/088; B62D 21/152

(57) ABSTRACT

A vehicle structure capable of achieving good load transfer performance is provided in the disclosure. The vehicle structure includes a pair of side frames, a shock absorber housing, a frame member that is connected to the side frames and is equipped with an auxiliary device, and a bulkhead that is disposed within a cross section of the side frames and is connected to at least one of a side surface portion and a lower surface portion of the side frames, as well as to an upper surface portion. The bulkhead includes a housing connection portion that is a portion of the bulkhead connected to a junction of the shock absorber housing and the upper surface portion, and a frame connection portion that is a portion of the bulkhead connected to a junction of the frame member and one of the side surface portion and the lower surface portion.

### CROSS-REFERENCE TO RELATED APPLICATION

This application claims the priority benefit of China application serial no. 202510146663.2, filed on February 10, 2025. The entirety of the above-mentioned patent application is hereby incorporated by reference herein and made a part of this specification.

### BACKGROUND

### Technical Field

The disclosure relates to a vehicle structure.

### Description of Related Art

In recent years, efforts have been actively made to provide access to sustainable transportation systems for those in vulnerable positions, such as the elderly, the disabled, or children. In order to achieve the above-mentioned purpose, research and development are devoted to further improving the safety and convenience of traffic through developments related to collision safety performance.

In the past, various vehicle structures have been researched and developed in response to various requirements on how to effectively transfer loads during collisions. The present case aims to address the aforementioned challenges with the objective of enhancing collision safety performance. Moreover, it further contributes to the development of sustainable transportation systems.

### SUMMARY

A vehicle structure capable of achieving good load transfer performance is provided in the disclosure.

According to an embodiment of the disclosure, the vehicle structure includes a pair of side frames, a shock absorber housing, a frame member that is connected to the pair of side frames and is equipped with an auxiliary device, and a bulkhead that is disposed within a cross section of the side frame and is connected to at least one of a side surface portion and a lower surface portion of the side frame, as well as to an upper surface portion. The bulkhead includes a housing connection portion that is a portion of the bulkhead connected to a junction of the shock absorber housing and the upper surface portion of the side frame, and a frame connection portion that is a portion of the bulkhead connected to a junction of the frame member and one of the side surface portion and the lower surface portion of the side frame.

Based on the above, in an embodiment of the disclosure, the vehicle structure may form a load transfer path between components such as the bulkhead, the shock absorber housing, the side frame and the frame member through the configuration of the bulkhead connected to at least one of the side surface portion and the lower surface portion of the side frame, as well as the upper surface portion of the side frame. In this way, during vehicle operation of the vehicle structure, the vertical load input from the suspension system to the shock absorber housing may be transferred to the frame member via the bulkhead. Furthermore, the horizontal loads resulting from torsion of the vehicle body and other causes may also be transferred and distributed from the frame member through the bulkhead to the shock absorber housing. Therefore, regardless of whether the input load during vehicle operation or upon collision originates from the vertical or horizontal direction, the vehicle structure, through the configuration of the bulkhead connecting the shock absorber housing to the frame components, is capable of transferring the load to a larger area than before. Consequently, this configuration may achieve good load transfer performance.

In order to make the above-mentioned features and advantages of the disclosure comprehensible, embodiments accompanied with drawings are described in detail below.

### BRIEF DESCRIPTION OF THE DRAWINGS

FIG. 1 is a partial three-dimensional schematic diagram of a vehicle structure according to an embodiment of the disclosure.

FIG. 2 is a partial bottom view of the front structure of the vehicle of FIG. 1.

FIG. 3 is a partial three-dimensional schematic diagram of the front structure of the vehicle shown in FIG. 1 near the shock absorber housing.

FIG. 4 is a partial enlarged schematic diagram of the vehicle structure shown in FIG. 3 near the first frame fixing portion.

FIG. 5 is a partial enlarged schematic diagram of the side frame shown in FIG. 3 near the first frame fixing portion.

FIG. 6 is a partial three-dimensional schematic diagram of the front structure of the vehicle shown in FIG. 1 near the second frame fixing portion.

FIG. 7 is a side view schematic diagram of the front structure of the vehicle shown in FIG. 3.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

In one embodiment of the disclosure, when viewed from above, the shock absorber housing has a front surface portion and a front flange portion in an upper area overlapping the side frame. The front surface portion extends in a vehicle height direction and a vehicle width direction. The front flange portion extends from a lower end of the front surface portion relative to the upper surface portion of the side frame. The front flange portion is connected to the housing connection portion.

In one embodiment of the disclosure, the frame member includes a first frame portion extending along a vehicle width direction, a second frame portion connected to the first frame portion, and multiple frame fixing portions extending from the second frame portion and connected to the side frame. At least one of the frame fixing portions is connected to the frame connection portion.

In one embodiment of the disclosure, a plurality of the frame connection portions are provided and are respectively located on both sides of the vehicle width direction. The frame fixing portion has a first frame fixing portion and a second frame fixing portion. The first frame fixing portion is disposed corresponding to the frame connection portion located on one side of the vehicle width direction, and the second frame fixing portion is disposed corresponding to the frame connection portion located on another side of the vehicle width direction. The first frame fixing portion is connected to one of the frame connection portions disposed on the lower surface portion of the side frame.

In one embodiment of the disclosure, the second frame fixing portion is connected to another one of the frame connection portions disposed on the side surface portion of the side frame.

In one embodiment of the disclosure, a plurality of the first frame portions of the frame member are provided, and one of the first frame portions is a front first frame portion. The front first frame portion is disposed on a front side of a vehicle, and is disposed in front of the frame fixing portion. The side frame has a concave-convex shape at a position where the side frame overlaps with the front first frame portion in a vehicle length direction.

In one embodiment of the disclosure, the side surface portion or the lower surface portion of the side frame has an insertion hole. The frame connection portion has a fastening hole corresponding to the insertion hole and a fastening member corresponding to the fastening hole. The fastening member and the frame member are mechanically fastened together through the insertion hole.

In one embodiment of the disclosure, the housing connection portion and the frame connection portion overlap in a vehicle length direction.

In one embodiment of the disclosure, the side frame has a side frame inner part and a side frame outer part. The side frame inner part has a hat-shaped portion that is open to an outer side in the vehicle width direction. The side frame outer part closes the hat-shaped portion. The side frame inner part and the side frame outer part form the cross section of the side frame by joining an upper flange disposed above the hat-shaped portion and a lower flange disposed below the hat-shaped portion. The shock absorber housing has a cutout portion. The cutout portion extends across the front surface portion and the front flange portion and is formed on the outer side in the vehicle width direction. The cutout portion is configured to be separated from the upper flange in the vehicle width direction.

In one embodiment of the disclosure, the upper flange has a flange extension portion, and the flange extension portion extends upward from the vehicle at a position overlapping with the cutout portion in the vehicle length direction.

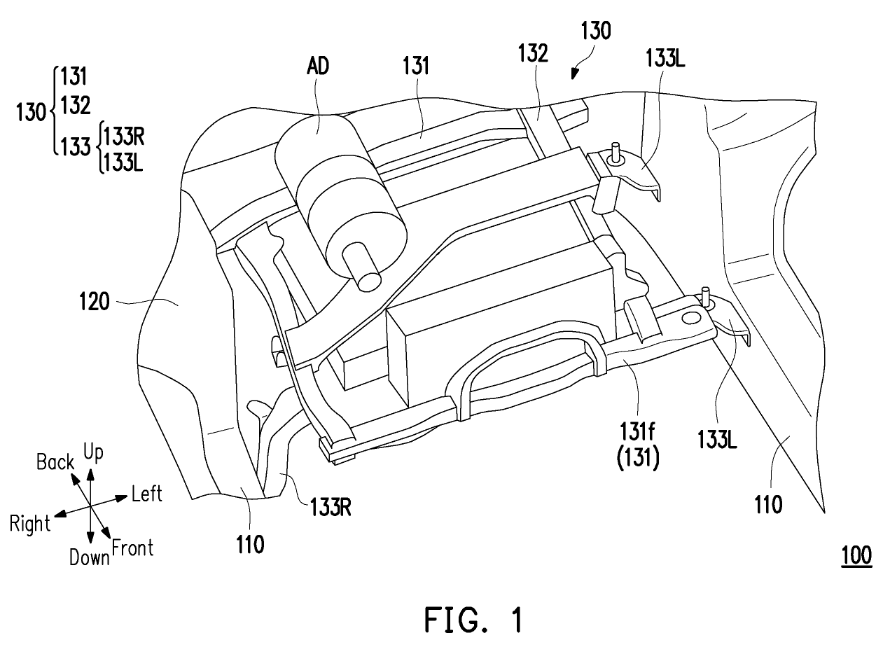

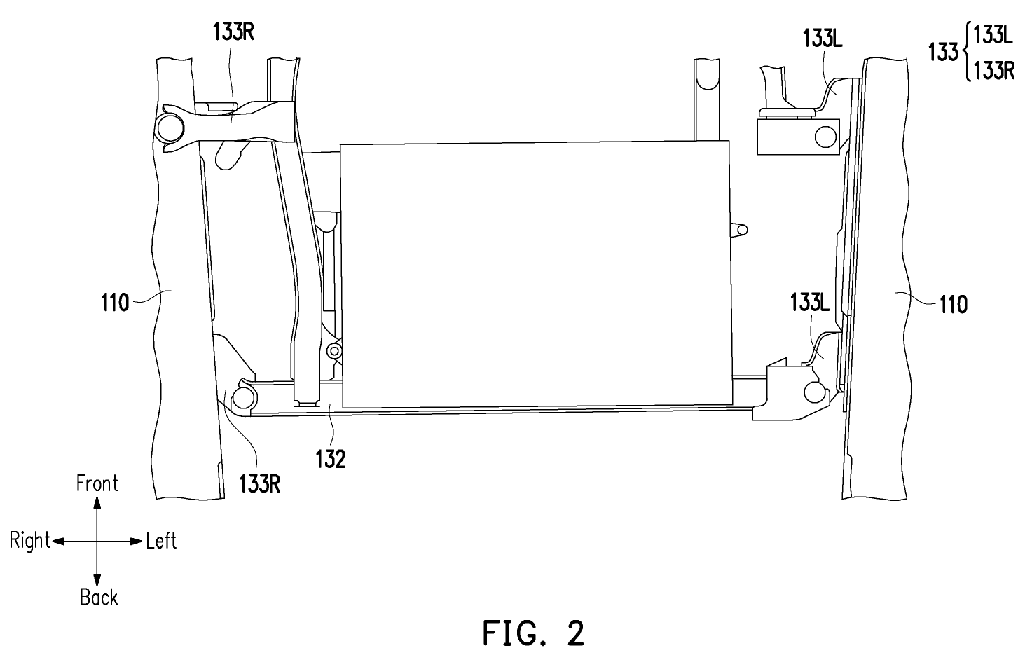

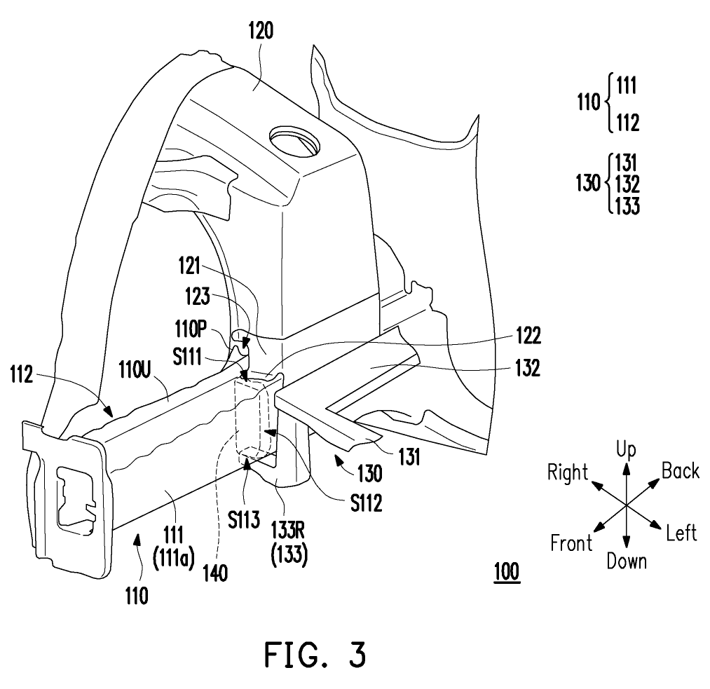

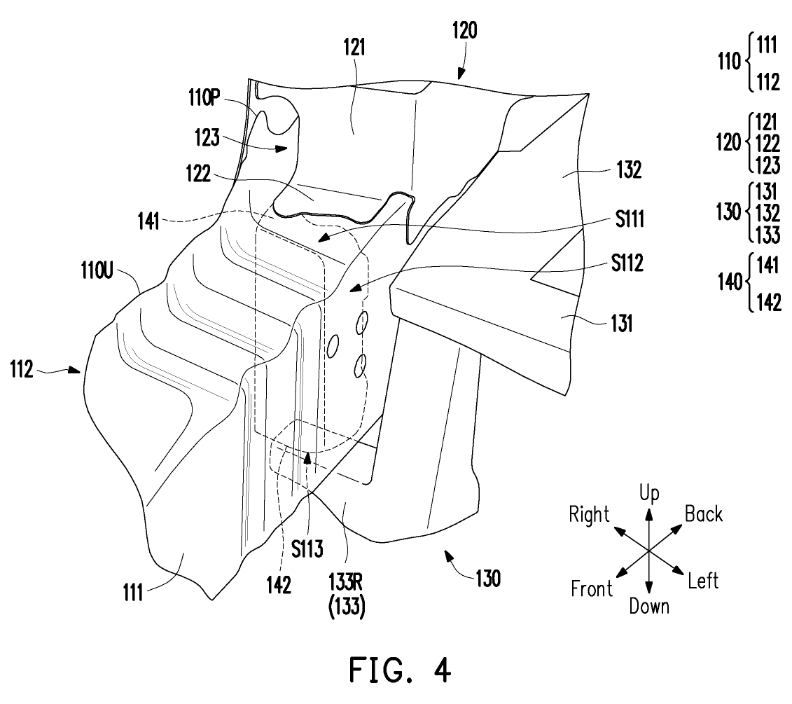

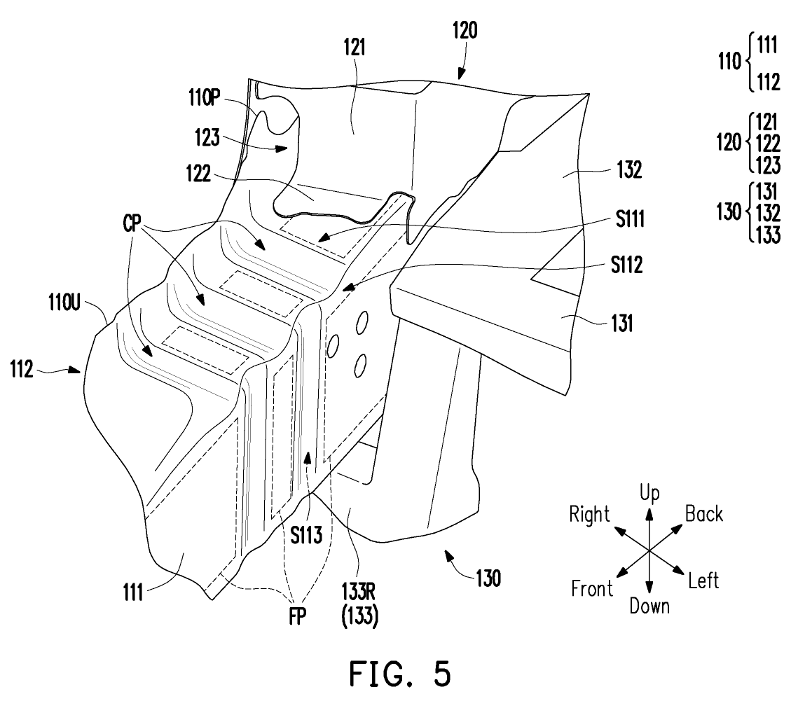

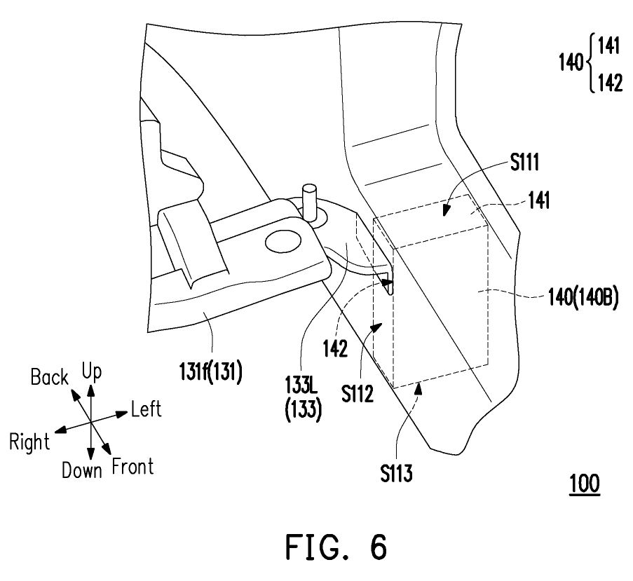

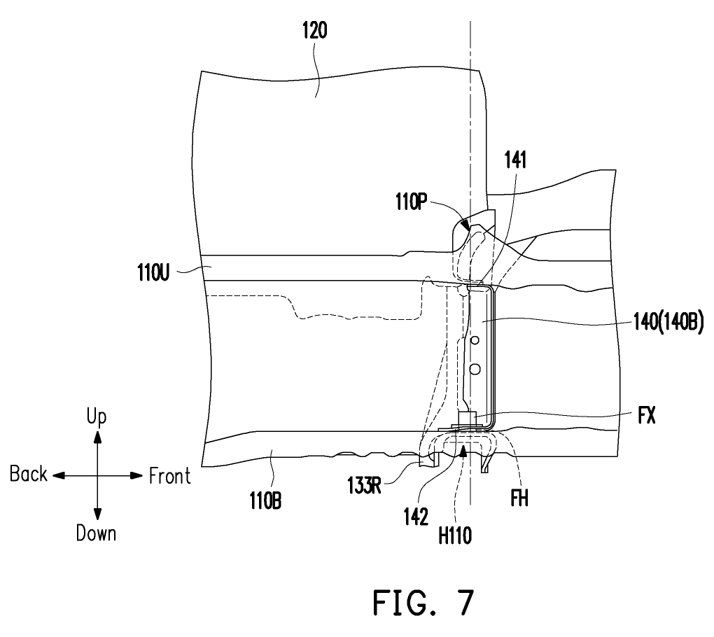

FIG. 1 is a partial three-dimensional schematic diagram of a vehicle structure according to an embodiment of the disclosure. FIG. 2 is a partial bottom view of the front structure of the vehicle of FIG. 1. FIG. 3 is a partial three-dimensional schematic diagram of the front structure of the vehicle shown in FIG. 1 near the shock absorber housing. FIG. 4 is a partial enlarged schematic diagram of the vehicle structure shown in FIG. 3 near the first frame fixing portion. FIG. 5 is a partial enlarged schematic diagram of the side frame shown in FIG. 3 near the first frame fixing portion. FIG. 6 is a partial three-dimensional schematic diagram of the front structure of the vehicle shown in FIG. 1 near the second frame fixing portion. FIG. 7 is a side view schematic diagram of the front structure of the vehicle shown in FIG. 3. It should be noted that, for the sake of convenience, the front and back directions, left and right directions, and up and down directions of the vehicle are defined as shown in the figures. According to this definition, the composition of each part is described, with the front and back directions, left and right directions, and up and down directions corresponding respectively to the vehicle length direction, vehicle width direction, and vehicle height direction.

Referring to FIG. 1 to FIG. 5, in this embodiment, a vehicle structure 100 includes a pair of side frames 110, a shock absorber housing 120, a frame member 130, and a bulkhead 140. The shock absorber housing 120 is configured to support a suspension system, and its structure has strength and rigidity. The frame member 130 is connected to the pair of side frames 110 and carries an auxiliary device AD. In this embodiment, the auxiliary device AD is, for example, a device for driving an electric vehicle, such as a battery, a compressor, etc., but the disclosure is not limited thereto. In other embodiments, the auxiliary device AD may also be a device such as an electric motor or a heat exchanger (radiator, condenser), as long as the item may be installed on the frame member 130 connected to the side frame 110, it may be considered as the auxiliary equipment AD in the vehicle. The bulkhead 140 is disposed within the cross section of the side frame 110 and is connected to at least one of the side surface portion S112 and the lower surface portion S113 of the side frame 110, as well as the upper surface portion S111. The bulkhead 140 includes a housing connection portion 141 and a frame connection portion 142. The housing connection portion 141 is a portion of the bulkhead 140 connected to the junction of the shock absorber housing 120 and the upper surface portion S111 of the side frame 110, and the frame connection portion 142 is a portion of the bulkhead 140 connected to the junction of the frame member 130 and one of the side surface portion S112 and the lower surface portion S113 of the side frame 110.

In this way, through the configuration of the bulkhead 140 connected to at least one of the side surface portion S112 and the lower surface portion S113 of the side frame 110 as well as the upper surface portion S111 of the side frame 110, the housing connection portion 141 of the bulkhead 140 may be disposed at the junction of the shock absorber housing 120 and the upper surface portion S111 of the side frame 110. This configuration joins the bulkhead 140, the shock absorber housing 120, and the side frame 110, thereby forming a load transfer path.

Furthermore, as shown in FIG. 3 and FIG. 4, in this embodiment, when viewed from above, the shock absorber housing 120 has a front surface portion 121, a front flange portion 122 and a cutout portion 123 in the upper area overlapping the side frame 110. The front surface portion 121 extends in the vehicle height direction and the vehicle width direction. The front flange portion 122 extends from the lower end of the front surface portion 121 relative to the upper surface portion S111 of the side frame 110. The front flange portion 122 is connected to the housing connection portion 141. The cutout portion 123 extends across the front surface portion 121 and the front flange portion 122 and is formed on the outer side in the vehicle width direction. Furthermore, in this embodiment, the side frame 110 has a side frame inner part 111 and a side frame outer part 112. The side frame inner part 111 has a hat-shaped portion 111a that is open to the outer side in the vehicle width direction. The side frame outer part 112 closes the hat-shaped portion 111a. The side frame inner part 111 and the side frame outer part 112 form a cross section of the side frame 110 by joining an upper flange 110U disposed above the hat-shaped portion 111a and a lower flange 110B disposed below the hat-shaped portion 111a. The cutout portion 123 of the shock absorber housing 120 is configured to be separated from the upper flange 110U in the vehicle width direction. The upper flange 110U of the side frame inner part 111 has a flange extension portion 110P that extends upward from the vehicle at a position overlapping with the cutout portion 123 in the vehicle length direction.

In this way, through the configuration of the front surface portion 121 and the front flange portion 122 of the shock absorber housing 120 in the upper area overlapping with the side frame 110, the vertical load input to the shock absorber housing 120 may be transferred downward from the front surface portion 121 through the front flange portion 122, allowing the load to be transferred to the bulkhead 140 without altering its direction. Furthermore, by implementing a structure in which the cutout portion 123 of the shock absorber housing 120 is configured to be separated from the upper flange 110U of the side frame 110, the vertical load input to the shock absorber housing 120 is not easily transferred to the upper flange 110U of the side frame 110. Consequently, this facilitates the transfer of the load to the bulkhead 140. Furthermore, through the configuration of the flange extension portion 110P of the upper flange 110U of the side frame inner part 111, the joint area between the side frame inner part 111 and the side frame outer part 112 may be expanded and reinforced in the vehicle height direction, and deformation of the cross section of the side frame 110 may be suppressed when the vertical load input to the shock absorber housing 120 is transferred to the bulkhead 140.

Furthermore, as shown in FIG. 3 and FIG. 4, in this embodiment, the housing connection portion 141 and the frame connection portion 142 overlap in the vehicle length direction. In this way, by configuring the housing connection portion 141 and the frame connection portion 142 of the bulkhead 140 to overlap in the vehicle length direction, that is, by structuring the main body portion 140B of the bulkhead 140 to extend in the vehicle height direction, the vertical load input to the shock absorber housing 120 may be appropriately transferred to the frame member 130 below through the bulkhead 140 extending in the vehicle height direction.

Furthermore, referring to FIG. 1 and FIG. 2 again, in this embodiment, the frame member 130 is a structure having the strength and rigidity to support the auxiliary device AD, and includes a first frame portion 131, a second frame portion 132 and multiple frame fixing portions 133. The first frame portion 131 extends along the vehicle width direction. The second frame portion 132 is connected to the first frame portion 131. In this embodiment, the second frame portion 132 extends, for example, along the vehicle length direction, but the disclosure is not limited thereto. In other embodiments, the second frame portion 132 may also extend along other directions (e.g., extending in an obliquely intersecting manner to connect to the first frame portion 131), provided that it may be securely connected to the first frame portion 131. The frame fixing portions 133 extend from the second frame portion 132 and are connected to the side frame 110, and at least one of the frame fixing portions 133 is connected to the frame connection portion 142. Furthermore, through the configuration of the bulkhead 140 connected to at least one of the side surface portion S112 and the lower surface portion S113 of the side frame 110 as well as the upper surface portion S111 of the side frame 110, the frame connection portion 142 of the bulkhead 140 may also be disposed at the junction of the frame member 130 and one of the side surface portion S112 and the lower surface of the side frame 110. This configuration joins the bulkhead 140, the frame member 130 and the side frame 110. In this way, the load input to the shock absorber housing 120 may be transferred to the frame fixing portion 133 connected to the frame connection portion 142 of the bulkhead 140. The load is then transferred by the frame fixing portion 133 to the second frame portion 132, and then transferred to the first frame portion 131 connected to the second frame portion 132. Consequently, the load may be transferred and distributed across the entirety of the frame member 130.

In this way, during vehicle operation of the vehicle structure 100, the vertical load input from the suspension system to the shock absorber housing 120 may be transferred to the frame member 130 via the bulkhead 140. Furthermore, the horizontal loads resulting from torsion of the vehicle body and other causes may also be transferred and distributed from the frame member 130 through the bulkhead 140 to the shock absorber housing 120. Therefore, regardless of whether the input load during vehicle operation or upon collision originates from the vertical or horizontal direction, the vehicle structure 100, through the configuration of the bulkhead 140 connecting the shock absorber housing 120 to the frame components, is capable of transferring the load to a larger area than before. Consequently, this configuration may achieve good load transfer performance.

In addition, as shown in FIG. 1, FIG. 2 and FIG. 6, in this embodiment, multiple frame connection portions 142 are provided and are respectively located on both sides of the vehicle width direction. The frame fixing portion 133 has a first frame fixing portion 133R and a second frame fixing portion 133L. The first frame fixing portion 133R is disposed corresponding to the frame connection portion 142 located on one side of the vehicle width direction, and the second frame fixing portion 133L is disposed corresponding to the frame connection portion 142 located on another side of the vehicle width direction. The first frame fixing portion 133R is connected to one of the frame connection portions 142 disposed on the lower surface portion S113 of the side frame 110, and the second frame fixing portion 133L is connected to another frame connection portion 142 disposed on the side surface portion S112 of the side frame 110.

Through the above configuration, the frame member 130, at a position corresponding to the bulkhead 140, may connect the first frame fixing portion 133R with one of the frame connection portions 142 disposed on the lower surface portion S113 of the side frame 110, and connect the second frame fixing portion 133L with another frame connection portion 142 disposed on the side surface portion S112 of the side frame 110. This configuration allows the frame fixing portion 133 to be fixed at a position reinforced by the bulkhead 140. In this way, the frame member 130 may be supported and fixed without being restricted by a fixed position, even on the side or beneath the side frame 110. Consequently, the frame member 130 may have an asymmetric installation structure, that is, on both sides in the vehicle width direction, the first frame fixing portion 133R and the second frame fixing portion 133L of the frame member 130 may be fixed at different heights.

On the other hand, as shown in FIG. 1, FIG. 4 and FIG. 5, in this embodiment, multiple first frame portions 131 of the frame member 130 are provided, and one of the first frame portions 131 is a front first frame portion 131f. The front first frame portion 131f is disposed on the front side of the vehicle and in front of the frame fixing portion 133. The position where the side frame 110 overlaps with the front first frame portion 131f in the vehicle length direction is a concave-convex portion CP having a concave-convex shape, and the area of the side frame 110 between the shock absorber housing 120 and the frame member 130 where the bulkhead 140 is disposed (the position corresponding to the frame fixing portion 133) is a flat surface portion FP without any unevenness. Thus, when a collision load from the front of the vehicle is applied on the side frame 110, the area of the side frame 110 between the shock absorber housing 120 and the frame member 130 where the bulkhead 140 is disposed (the position corresponding to the frame fixing portion 133) is a flat surface portion FP without any unevenness. Therefore, the cross section of the side frame 110 at this position is not excessively deformed. On the other hand, since the side frame 110 has a concave-convex portion CP at a position overlapping with the front first frame portion 131f located in front of the frame fixing portion 133, by adjusting the concave-convex shape of the concave-convex portion CP, the area up to the front of the bulkhead 140 may designated as the area for cross-sectional deformation (compressive deformation or bending deformation) of the side frame 110. In this way, the installation area of bulkhead 140 (the position corresponding to the frame fixing portion 133) may be utilized as a boundary to create a differential in strength, thereby stabilizing the fracture mode during a collision. Consequently, this prevents the collapse of the cross section of the structure and enhances its rigidity performance.

In addition, as shown in FIG. 7, in this embodiment, the side surface portion S112 or the lower surface portion S113 of the side frame 110 has an insertion hole H110. The frame connection portion 142 has a fastening hole FH corresponding to the insertion hole H110 and a fastening member FX corresponding to the fastening hole FH. The fastening member FX and the frame member 130 are mechanically fastened together through the insertion hole H110. For example, in this embodiment, the fastening member FX may be a bolt and a nut. In this way, since the bulkhead 140 and the frame member 130 are mechanically fixed through the insertion hole H110 of the side frame 110, the shape of the frame member 130 may be appropriately changed in accordance with the load serving as the auxiliary device AD disposed on the frame member 130 or the load weight thereon, thereby adapting to the requirements of different vehicle models.

To sum up, in an embodiment of the disclosure, the vehicle structure may form a load transfer path between components such as the bulkhead, the shock absorber housing, the side frame and the frame member through the configuration of the bulkhead connected to at least one of the side surface portion and the lower surface portion of the side frame, as well as the upper surface portion of the side frame. In this way, during vehicle operation, the vertical load input from the suspension system to the shock absorber housing may be transferred to the frame member via the bulkhead. Furthermore, the horizontal loads resulting from torsion of the vehicle body and other causes may also be transferred and distributed from the frame member through the bulkhead to the shock absorber housing. Therefore, regardless of whether the input load during vehicle operation or upon collision originates from the vertical or horizontal direction, the vehicle structure, through the configuration of the bulkhead connecting the shock absorber housing to the frame components, is capable of transferring the load to a larger area than before. Consequently, this configuration may achieve good load transfer performance.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A vehicle structure, comprising:
a pair of side frames;
a shock absorber housing;
a frame member, connected to the pair of side frames and equipped with an auxiliary device; and
a bulkhead, disposed within a cross section of the side frame and connected to at least one of the side surface portion and a lower surface portion of the side frame, as well as to an upper surface portion, the bulkhead comprising:
a housing connection portion, being a portion of the bulkhead connected to a junction of the shock absorber housing and the upper surface portion of the side frame; and
a frame connection portion, being a portion of the bulkhead connected to a junction of the frame member and one of the side surface portion and the lower surface portion of the side frame.

2. The vehicle structure according to claim 1, wherein, when viewed from above, the shock absorber housing has a front surface portion and a front flange portion in an upper area overlapping the side frame, the front surface portion extends in a vehicle height direction and a vehicle width direction, the front flange portion extends from a lower end of the front surface portion relative to the upper surface portion of the side frame, the front flange portion is connected to the housing connection portion.

3. The vehicle structure according to claim 1, wherein, the frame member comprises:
a first frame portion, extending along a vehicle width direction;
a second frame portion, connected to the first frame portion; and
a plurality of frame fixing portions, extending from the second frame portion and connected to the side frame, wherein at least one of the frame fixing portions is connected to the frame connection portion.

4. The vehicle structure according to claim 3, wherein, a plurality of the frame connection portions are provided and are respectively located on both sides of the vehicle width direction,
the frame fixing portion has a first frame fixing portion and a second frame fixing portion, the first frame fixing portion is disposed corresponding to the frame connection portion located on one side of the vehicle width direction, the second frame fixing portion is disposed corresponding to the frame connection portion located on another side of the vehicle width direction, and the first frame fixing portion is connected to one of the frame connection portions disposed on the lower surface portion of the side frame.

5. The vehicle structure according to claim 4, wherein, the second frame fixing portion is connected to another one of the frame connection portions disposed on the side surface portion of the side frame.

6. The vehicle structure according to claim 3, wherein, a plurality of the first frame portions of the frame member are provided, and one of the first frame portions is a front first frame portion, the front first frame portion is disposed on a front side of a vehicle, and is disposed in front of the frame fixing portion, the side frame has a concave-convex shape at a position where the side frame overlaps with the front first frame portion in a vehicle length direction.

7. The vehicle structure according to claim 1, wherein, the side surface portion or the lower surface portion of the side frame has an insertion hole, the frame connection portion has a fastening hole corresponding to the insertion hole and a fastening member corresponding to the fastening hole, the fastening member and the frame member are mechanically fastened together through the insertion hole.

8. The vehicle structure according to claim 2, wherein, the housing connection portion and the frame connection portion overlap in a vehicle length direction.

9. The vehicle structure according to claim 8, wherein, the side frame has a side frame inner part and a side frame outer part, the side frame inner part has a hat-shaped portion that is open to an outer side in the vehicle width direction, the side frame outer part closes the hat-shaped portion, the side frame inner part and the side frame outer part form the cross section of the side frame by joining an upper flange disposed above the hat-shaped portion and a lower flange disposed below the hat-shaped portion, the shock absorber housing has a cutout portion, the cutout portion extends across the front surface portion and the front flange portion and is formed on the outer side in the vehicle width direction, the cutout portion is configured to be separated from the upper flange in the vehicle width direction.

10. The vehicle structure according to claim 9, wherein, the upper flange has a flange extension portion, the flange extension portion extends upward at a position overlapping with the cutout portion in the vehicle length direction.
